(19) United States
(12) Patent Application Publication
(10) Pub. No.: US 2015/0034021 A1
(43) Pub. Date: Feb. 5, 2015

(54) Veterinary Covering Support for Incision or Wound Site

(71) Applicant: Keith Vogt, Truckee, CA (US)

(72) Inventor: Keith Vogt, Truckee, CA (US)

(21) Appl. No.: 13/957,523

(22) Filed: Aug. 2, 2013

(51) Int. Cl. A01K 13/00

(52) U.S. Cl. CPC A01K 13/006
USPC 119/850

(57) ABSTRACT

A veterinary harness is provided that provides a body covering over a wound site, incision, or injury that prevents the animal from licking or otherwise inspecting the area. The harness comprises a body portion having a covering and a padded offset member that is positioned over a wounded area, wherein the offset member maintains a gap between the covering and the wound. The covering includes a breathable construction, which combined with the offset allows ready airflow through the device and to the wound site. The body portion includes elongated straps that secure around the animal torso, while a forward strap assembly secures around the shoulders of the animal to maintain the body portion position. The device is ideally suited for covering open wounds and surgical dressings on animals without utilizing an Elizabethan collar to prevent access thereto.

### BACKGROUND OF THE INVENTION

1. Field of the Invention

The present invention relates to animal covers and animal harnesses that are adapted to surround the torso of an animal. More specifically, the present invention pertains to a veterinary shielding harness that restricts access to a recent incision or wound site along an animal's torso and prevents the animal from otherwise investigating the site.

Wound licking in animals is a common instinctive behavior that causes the animal to persistently lick open wounds or perceived injuries. While evidence has shown that there are some benefits introducing saliva onto a wound site for both cleaning the wound and accelerating the healing process, licking can also abrade the area, cause damage to the animal's coat and skin, and further create contamination or introduce infections to a wound site. For domestic animals, veterinarians direct pet owners take steps to prevent animals from licking incision sites after surgical procedures, as the incisions site can be opened by the licking action and the animal can be exposed to ingestion of wound site topical treatments. These generally include antibacterial gels and the like that can be harmful to the animal if ingested.

A common solution for preventing animals from wound licking is an Elizabethan collar, or pet cone device. A pet cone, as the name suggests, is a cone structure that surrounds a pet's neck and extends outward around the animal's head. The cone terminates beyond the animal's snout such that the animal readily cannot turn its head and obtain access to its legs or torso area where a wound site may be located. The cone therefore acts as a shield or barrier to prevent physical access. While an effective solution, pet cones are intrusive, unsightly, and not comfortable for the pet to wear for long periods.

The present invention pertains to a new and novel means of blocking access to a wound site along an animal's body, whereby the device is particularly suited for wound sites along the animal's torso area. The device provides a secure animal harness around the animal's body that supports an offset covering over a wound site, where the device is secure, restricts access to prevent licking, and further allows open air flow to the wound or incision site for more rapid healing thereof. The harness is attached around the animal's torso and over the animal's shoulder and connects to a body portion having a padded, offset area that blocks the wound site from direct contact and allows air to penetrate therethrough to the wound.

### DESCRIPTION OF THE PRIOR ART

Devices have been disclosed in the prior art that relate to animal harnesses. These include devices that have been patented and published in patent application publications, and generally relate to animal harnesses that fail to disclose a means of protecting a wound site or incision location. The devices in the prior art further fail to disclose the structural aspects of the present harness device. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 5,503,113 to Knight discloses a pet harness that includes a shoulder strap and a torso strap, where the two straps secure together along the animal's back at a connection for a leash. U.S. Pat. No. 5,611,298 to Sporn discloses a dog harness having a shoulder junction, a pair of side openings to accept a dog's front legs, and a chest junction that crosses the dog's chest across the shoulders. Similarly, U.S. Pat. No. 8,261,699 to Cho discloses a pet harness that includes a shoulder and torso strap that prevents choking of the pet. A center padded portion is provided over the pet's chest and provides support of the shoulder and torso straps.

The Knight, Sporn, and Cho devices disclose typical pet harnesses in the prior art, where the key focus is controlling a pet during a walk. The devices are adapted to provide improved control over the animal while not choking, rubbing, or otherwise harming the animal in the process. A harness of this type is ideal for directing the motion of a large pet and maintaining control over its movement while on a walk or in crowded areas. These devices, however, fail to provide support for a surface that is suited for covering and protecting an incision or wound along an animal's torso. The present invention combines an animal harness with a veterinary covering, which prevents licking of a sensitive area and maintains an offset between the covering and the affected area.

Still other devices relate to harnesses having a chest pad or body portion integrated into the animal harness. U.S. Pat. No. 4,559,906 to Smith discloses a small animal harness that includes a main body portion that is positioned under a pet's torso and attached thereto by straps that surround the back of the animal near the pet's forward and rear legs. A handle is provided for lifting the animal, wherein the body portion bears against the pet and the pet is readily lifted by an owner's single hand. The Smith device, while suitable for lifting small dogs, provides no means of shrouding a wound from licking and protecting the same from abrasion and wear. The present invention comprises a body portion that is offset from the wound area to prevent rubbing or irritation of the area, while the covering itself is breathable to promote healing of the skin and vent moisture therefrom.

Similar to the Smith device, U.S. Pat. No. 7,497,186 to Dorton describes an animal harness that includes a self-carried hydration system thereon. The harness secures along the animal's chest area and is supported by straps across the animal body, wherefrom a fluid dispensing mechanism is provided in connection with a fluid container and harness pocket therefor. The device allows an owner hydrate a work animal or pet with fluid carried by the animal. While providing a body portion that secures across the chest of the animal, no mechanism for attending to wounds or incision areas is provided.

It is submitted that no animal torso harness are present in the prior art that are adapted for supporting a wound dressing and for preventing access to the wound site for the animal to lick or otherwise agitate the wound. The present invention provides a harness having a body portion that supports a movable and securable pad, wherein the pad presses the harness body portion away from the wound while it extends over the wound. The body portion itself is breathable to allow in oxygen for improved healing.

The present invention is therefore substantially divergent in design elements from the prior art and consequently it is clear that there is a need in the art for an improvement to existing veterinarian wound and incision covers for use with animals and pets. In this regard the instant invention substantially fulfills these needs.

### SUMMARY OF THE INVENTION

In view of the foregoing disadvantages inherent in the known types of body coverings and animal harnesses now present in the prior art, the present invention provides a new veterinary wound covering support that can be utilized for providing convenience for the user when shielding a wound or incision location from inspection by an animal, while providing a means of allowing air to reach the site while the device is in use.

It is therefore an object of the present invention to provide a new and improved veterinary wound covering support that has all of the advantages of the prior art and none of the disadvantages.

It is another object of the present invention to provide a veterinary wound covering support that includes a secure harness that maintains a static support for a wound covering or an incision dressing covering, whereby the animal cannot remove the harness, the harness does not rub against the animal, and the wound is not interfered with.

Another object of the present invention is to provide a veterinary wound covering support that includes a body region adapted to shroud a wound or incision site on an animal and prevent access thereto, so as to prevent licking, biting or other activity in which an animal may otherwise instinctively engage in around the wound site.

Yet another object of the present invention is to provide a veterinary wound covering support that includes a body region offset from the wound site by way of a thickened pad, whereby the body region itself is not in contact with the animal or wound site.

Another object of the present invention is to provide a veterinary wound covering support that includes a breathable body region to allow air penetration for improved healing of open wounds and incisions.

A final object of the present invention is to provide a veterinary wound covering support that is comprised of materials that promote economy and reliability, whereby the device can be produced and sold at a reasonable price and thereafter utilized for long periods and over repeated uses.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the wound covering support harness in a working state, deployed on a pet canine animal.

FIG. 2 shows an overhead perspective view of the body portion of the present invention and the movable offset pad that is adapted to surround the wound site.

FIG. 3 shows the harness strap assembly of the present invention, which extends from the body section and secures over the chest and shoulders of an animal.

FIG. 4 shows an alternate configuration of the present invention, wherein the harness strap assembly comprises a singular chest strap.

### DETAILED DESCRIPTION OF THE INVENTION

Reference is made herein to the attached drawings. Like reference numerals are used throughout the drawings to depict like or similar elements of the veterinary wound covering support. For the purposes of presenting a brief and clear description of the present invention, the preferred embodiment will be discussed as used for shielding wounds and incisions sites on an animal's torso to prevent licking and eliminate the need for an Elizabethan collar device around the animal's neck. The figures are intended for representative purposes only and should not be considered to be limiting in any respect.

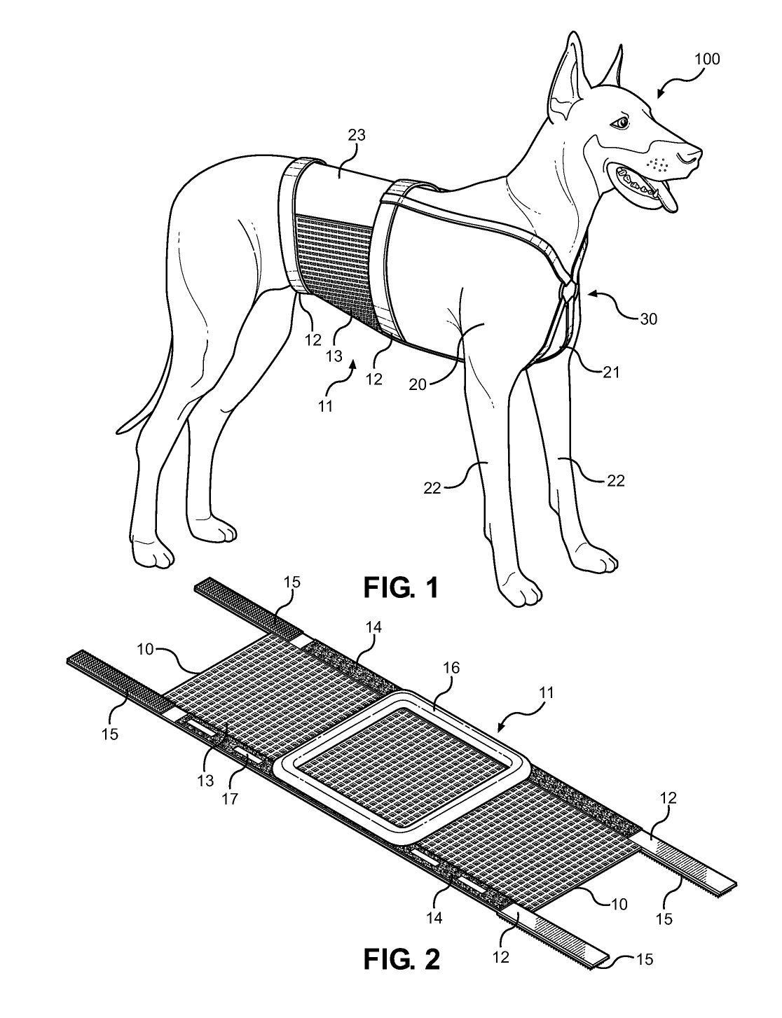

Referring now to FIG. 1, there is shown a view of the veterinary wound covering support of the present invention in a working state, applied to the torso 23 of a pet canine 100. The device comprises a harness having two primary portions: a harness body portion 11 supported around the perimeter of the animal's torso 23, and a forward strap assembly 30 that extends from the body portion 11 and maintains the longitudinal position of the device while the animal 100 is in motion. The strap assembly 30 comprises at least one strap that surrounds the chest 21 of the animal, providing clearance for the animal's shoulders 20 and forward legs 22 to operate unencumbered while the device is deployed.

The body portion 11 comprises an elongated covering 13 that is adapted to shroud a wound site or incision location along the animal's torso 23 and prevent access thereto. This prevents the animal 100 from licking, biting, or otherwise interrogating the wound and allows the wound time to heal without interference. The covering 13 is a perforated or mesh material that allows ready air flow across its surface, whereby air is introduced to the wound site for accelerated tissue growth, reduced moisture under the covering, and overall improved healing conditions. The covering 13 includes a first and second end and an upper and lower edge. The edges are supported by elongated harness straps 12 that extend around the animal's torso 23 and secure to one another. The ends of the harness straps 12 include fastening means to permit each end to be joined and the covering 13 to be supported in a secure manner around the animal.

Referring now to FIG. 2, there is shown a view of the harness body portion 11 of the present invention, which provides a secure shroud over a wound or incision location. The body portion 11 comprises an elongated covering 13 having a substantially rectangular shape, a first and second end 10, and an upper and lower edge bounded by elongated harness straps 12 secured thereto and extending therefrom. The straps 12 span the length of the covering 13 and extend outward from the covering 13. The ends of the straps 15 include strap end attachment means, such as hook and loop fastener strips, buckles, snaps, or buckle clips (hook and loop fasteners shown). The attachment means is any suitable strap attachment that allows the strap ends 15 to be secured together and the straps 12 to snugly secure the body portion 11 to the animal's torso area about the wound site.

The covering 13 includes a perforated or mesh construction that promotes air flow therethrough, while the strap area bounding the covering 11 comprises a strip of loop fasteners 14 there along. These provide a means to secure a movable, padded offset member 16 along the length of the covering. The offset member 16 comprises a largely rectangular structure having a perimeter thickness and an open interior, whereby the member is adapted to surround the wound site and separate the covering 13 from the wound area. The thickness of the member 16 creates an air gap between the wound site and the covering 13 material, preventing the covering 13 from adhering thereto and improving airflow to the wound. In a preferred embodiment, the offset member 16 includes hook attachment members along one side thereof to secure to the loop members 14 of the covering periphery. This secures the offset member 16 in a given location and prevents it from sliding or dislodging. In a simpler embodiment, the offset member location is maintain through compression of the harness itself, rather than by any attachment means.

Along one edge of the covering and through the corresponding strap member is disposed at least one aperture 17, which is adapted to accepted the strap ends of the forward strap assembly therethrough. The straps ends slide through the apertures 17 and secure back onto themselves, thereby preventing movement of the body portion 11 along the animal's torso. The strap assembly bears against the animal's chest and shoulder area to prevent sliding motion, while the straps 12 of the body portion 11 are snugly applied around the animal's torso.

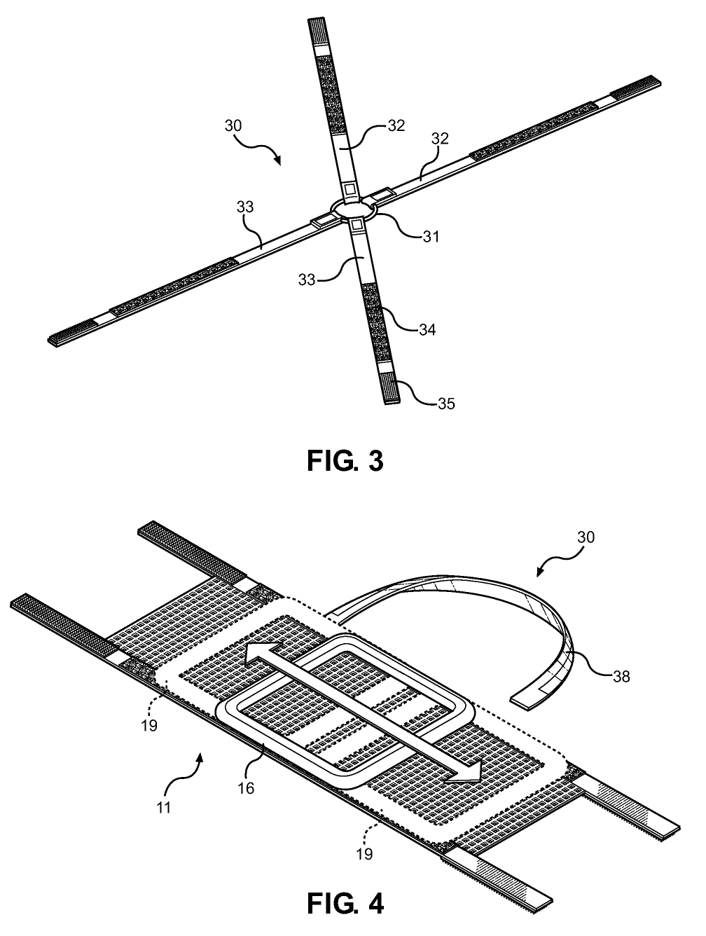

Referring now to FIG. 3, there is shown a view of the strap assembly 30 of the present invention. The strap assembly preferably comprises a first and second chest strap 33, and a first and second shoulder strap 32. The straps secure to a common ring 31 that is placed along the animal's chest area, wherefrom the shoulder straps 32 extends over the animal's shoulders and the chest straps extend downward along the animal's chest. The X-strap configuration allows free movement of the animal's shoulders on either side of the ring 31, while the ends of each strap engage the harness body portion along the animal torso.

In a preferred embodiment of the straps, each strap end includes a strap attachment means that allows the straps the surround a portion of the body portion and reconnect onto the itself. A distal end patch of hook fasteners 35 and a separated section of loop fasteners 35 allows for the body portion straps or the apertures to be surrounded and secured to the strap assembly straps, thereby establishing a continuous harness device that maintains the position of the harness covering while in use.

Referring now to FIG. 4, there is shown an embodiment of the present invention that includes a singular forward strap assembly 30. In this embodiment, the X-strap configuration is replaced by a singular strap 38 that surrounds the chest of the animal and extends over the shoulders thereof. This configuration represents a minimalist approach and a simpler design, but trades security of the body portion as the animal moves and his shoulders shift while walking.

Also visualized in FIG. 4 is the ability of the offset member 16 to shift position along the covering, whereby the member 16 may be positioned 19 along an end of the covering or centrally located thereon, as desired. Once the member 16 has been placed around the wound site, the straps of the body portion can be tightened around the animal and the forward strap assembly can be secured.

Overall, the device provides a secure means to cover an open wound, injury, or incision site on an animal, and prevents an animal from licking the same without an owner resorting to an Elizabethan collar. The collar approach is intrusive, unsightly, and uncomfortable for the animal. Placement of a harness that is adapted to act as a wound shroud or dressing cover greatly improves security of wound and accelerates the healing process. The device greatly improves upon the prior art in the area of wound covers, and provides a new and novel animal harness having a veterinary purpose.

It is submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A veterinary covering support for an incision or wound site, comprising:
a harness body portion having an elongated covering, said elongated covering having a first and second end and an upper and lower edge;
elongated harness straps secured to said covering upper and lower edge and extending therefrom;
said elongated straps having a first and second end and a strap attachment means to join each strap first and second end together, said straps adapted to surround an animal torso;
a forward strap assembly adapted to secure to said harness body portion and extend over an animal shoulder region;
a padded offset member comprising a largely rectangular structure having a perimeter thickness and an open interior, said offset member adapted to be positioned between said covering and said animal about a wound site.

2) The device of claim 1, wherein said elongated covering comprises a material that allows airflow thereacross.

3) The device of claim 2, wherein said elongated covering comprises a perforated material.

4) The device of claim 1, wherein said forward strap assembly comprises a singular strap that is adapted to surround the chest of an animal and extend over the shoulders thereof.

5) The device of claim 1, wherein said forward strap assembly comprises:
a first and second chest strap and a first and second shoulder strap;
said chest straps and shoulder straps secured to a common ring that is adapted to be placed along an animal's chest area, wherefrom said shoulder straps area adapted to extend over the animal's shoulders and said chest straps are adapted to extend along the animal's chest in an X-strap configuration.

6) The device of claim 1, wherein said padded offset member comprises an attachment means to said covering upper and lower edge.

7) The device of claim 1, wherein said covering upper edge further comprises apertures to accept said strap assembly straps therethrough.

8) A veterinary covering support for an incision or wound site, comprising:
a harness body portion having an elongated covering having a first and second end and an upper and lower edge;
elongated harness straps secured to said covering upper and lower edge and extending therefrom;
said elongated straps having a first and second end and a strap attachment means to join each strap first and second end together, said straps adapted to surround an animal torso;
a forward strap assembly adapted to secure to said harness body portion and extend over an animal shoulder region;
said elongated covering comprises a material that allows airflow thereacross.

9) The device of claim 8, wherein said elongated covering comprises a perforated material.

10) The device of claim 8, further comprising:
a padded offset member comprising a largely rectangular structure having a perimeter thickness and an open interior, said offset member adapted to be positioned between said covering and said animal about a wound site.

11) The device of claim 8, wherein said forward strap assembly comprises a singular strap that is adapted to surround the chest of an animal and extend over the shoulders thereof.

12) The device of claim 8, wherein said forward strap assembly comprises:
a first and second chest strap and a first and second shoulder strap;
said chest straps and shoulder straps secured to a common ring that is adapted to be placed along an animal's chest area, wherefrom said shoulder straps area adapted to extend over the animal's shoulders and said chest straps are adapted to extend along the animal's chest in an X-strap configuration.

13) The device of claim 8, wherein said padded offset member comprises an attachment means to said covering upper and lower edge.

14) The device of claim 8, wherein said covering upper edge further comprises apertures to accept said strap assembly straps therethrough.
